(19) United States
(12) Patent Application Publication
(10) Pub. No.: US 2020/0336852 A1
(43) Pub. Date: Oct. 22, 2020

(54) VIBRATING DIAPHRAGM FOR SOUND GENERATING DEVICE, METHOD FOR PREPARING VIBRATING DIAPHRAGM, AND SOUND GENERATING DEVICE

(71) Applicant: GOERTEK INC., Weifang City, Shandong (CN)

(72) Inventors: Houqiang Zhou, Weifang City, Shandong (CN); Ting Wang, Weifang City, Shandong (CN); Zengxun Wu, Weifang City, Shandong (CN)

(73) Assignee: Goertek Inc., Weifang City, Shandong (CN)

(21) Appl. No.: 16/956,708

(22) PCT Filed: Oct. 13, 2018
(86) PCT No.: PCT/CN2018/110160

§ 371 Date: Jun. 22, 2020

(30) Foreign Application Priority Data
Dec. 22, 2017 (CN) 201711407909.9

(51) Int. Cl. H04R 31/00; H04R 7/02; B29B 7/42; C08J 5/18; C08L 67/00; C08K 7/14; C08K 7/06; C08K 3/40; C08K 3/04; C08K 3/26; C08K 3/34

(52) U.S. Cl. CPC H04R 31/003; H04R 7/02; B29B 7/42; C08J 5/18; C08L 67/00; B29K 2101/12; C08K 7/06; C08K 3/40; C08K 3/04; C08K 3/26; C08K 3/346; C08K 7/14

(57) ABSTRACT

Disclosed are a vibrating diaphragm for a sound generating device, a method for preparing the vibrating diaphragm, and a sound generating device. The vibrating diaphragm comprises at least one modified thermoplastic polyester elastomer layer, wherein a modifier is involved which is at least one of a temperature: resistant resin, an inorganic filler and an anti-aging agent, and the modifier is added to a themoplastic polyester elastomer material. In an embodiment of the present invention, by adding the modifier to the themoplastic polyester elastomer material and sufficiently mixing the modifier when making a film layer, the aim of improving the temperature resistance of a moulded vibrating diaphragm is achieved.

### CROSS-REFERENCE TO RELATED APPLICATIONS

This application is a National Stage of International Application No. PCT/CN2018/110160, filed on Oct. 13. 2018, which claims priority to Chinese Patent Application No. 201711407909.9, filed on Dec. 22, 2017, both of which are hereby incorporated by reference in their entireties.

### TECHNICAL FIELD

The present disclosure relates to the technical field of electroacoustic conversion, and particularly to a vibrating diaphragm for a sound generating device, a method for preparing the vibrating diaphragm, and a sound generating device.

### BACKGROUND

Vibrating diaphragms of the existing loudspeakers mostly use materials of a composite structure in order to obtain an excellent comprehensive performance. For example, materials of a composite structure include three layers. Among the three layers, an engineering plastic (PEEK, PAR, PET, PI, PEI) with good temperature resistance and a high modulus is used for a substrate layer, an acrylic gel or a silica gel is used for a dumping layer, and a thermoplastic polyester elastomer (TPEE) material is used for a resilient layer.

The thermoplastic polyester elastomer (TPEE) can effectively improve resilience of a vibrating diaphragm, and reduce diaphragm fold of the vibrating diaphragm and distortions caused during a sudden vibration of the vibrating diaphragm.

However, the melting point of the thermoplastic polyester elastomer material is 180-220° C. As a result, when the high temperature reliability of the vibrating diaphragm is being verified, the thermoplastic polyester elastomer layer will melt within the temperature range, resulting in diaphragm breakage.

Therefore, there is a need to provide a vibrating diaphragm to improve the temperature resistance of the vibrating diaphragm.

### SUMMARY

One objective of the present disclosure is to provide a new technical solution of a vibrating diaphragm for a sound generating device.

According to a first aspect of the present disclosure, a vibrating diaphragm for a sound generating device is provided, which includes at least one modified thermoplastic polyester elastomer layer, wherein a modifier is at least one of a temperature-resistant resin, an inorganic filler and an anti-aging agent, and the modifier is added to a thermoplastic polyester elastomer material.

Optionally, the temperature-resistant resin is at least one of poly(ethyleneglycol o-phthalate), polyethylene naphthalate and poly 1,4-cyclohexylene dimethylene terephthalate.

Optionally, the inorganic filler is at least one of talc, calcium carbonate, glass fiber, carbon fiber, glass beads, and mica.

Optionally, under the condition that the modifier includes at least one of the temperature-resistant resin and the inorganic filler, the modifier further includes a coupling agent for improving bonding strength between the thermoplastic polyester elastomer material and at least one of the temperature-resistant resin and the inorganic filler.

Optionally, the coupling agent is selected from at least one of a silane coupling agent, an epoxy polymer coupling agent and a titanate coupling agent.

Optionally, an amount of the modifier added occupies less than or equal to 40% of a total mass of the modified thermoplastic polyester elastomer material.

Optionally, under the condition that the vibrating diaphragm includes two modified thermoplastic polyester elastomer layers, the vibrating diaphragm further includes a damping adhesive layer positioned between the two modified thermoplastic polyester elastomer layers.

Optionally, under the condition that the vibrating diaphragm includes one modified thermoplastic polyester elastomer layer, the vibrating diaphragm further includes a plastic base layer bonded to the modified thermoplastic polyester elastomer layer.

Optionally, under the condition that the vibrating diaphragm includes one modified thermoplastic polyester elastomer layer, the vibrating diaphragm further includes a plastic base layer and a damping adhesive layer positioned between the modified thermoplastic polyester elastomer layer and the plastic base layer.

According to another aspect of the present disclosure, a method for preparing a vibrating diaphragm is provided, which includes:

providing a thermoplastic polyester elastomer material and a modifier, wherein the modifier is at least one of a temperature-resistant resin, an inorganic filler and an anti-aging agent;

adding the modifier to the thermoplastic polyester elastomer material and mixing uniformly the modifier and the thermoplastic polyester elastomer material; and

moulding the modifier and the thermoplastic polyester elastomer material mixed to form a vibrating diaphragm.

Optionally, the adding the modifier to the thermoplastic polyester elastomer material and mixing uniformly the modifier and the thermoplastic polyester elastomer material includes: adding the thermoplastic polyester elastomer material and the modifier to a twin-screw extruder, and melt-mixing the thermoplastic polyester elastomer material and the modifier to form a uniform melt; or

mixing the thermoplastic polyester elastomer material and the modifier and preparing the thermoplastic polyester elastomer material and the modifier into a masterbatch; and adding the masterbatch and the thermoplastic polyester elastomer material to a single-screw extruder, and melt-mixing the masterbatch and the thermoplastic polyester elastomer material to form a uniform melt.

According to another aspect of the present disclosure, a sound generating device is provided, which includes the vibrating diaphragm for a sound generating device provided by the present disclosure.

Inventors of the present disclosure have found that in the prior art, the thermoplastic polyester elastomer material (TPEE) has a low melting point and is likely to melt when used at a high temperature, resulting in diaphragm breakage. Therefore, the technical tasks to be achieved or the technical problems to be solved by the present disclosure are unconceivable or unanticipated to those skilled in the art, and thus the present disclosure is a new technical solution.

In embodiments of the present disclosure, when preparing a diaphragm layer, a modifier is added to a thermoplastic polyester elastomer material and is sufficiently mixed therewith so as to achieve the aim of improving the temperature resistance of a vibrating diaphragm moulded. A temperature-resistant resin and an inorganic filler can be combined with the thermoplastic polyester elastomer material so as to increase a melting temperature of the modified thermoplastic polyester elastomer layer to improve the temperature resistance of the material. Besides, an anti-aging agent can delay an aging speed of the thermoplastic polyester elastomer material, thereby improving the temperature resistance of the material.

Additional features and advantages of the present disclosure will become apparent from the detailed description of the exemplary embodiments in combination with the drawings hereinafter.

### BRIEF DESCRIPTION OF THE DRAWINGS

The drawings combined into the Description and forming one part of the Description show embodiments of the present disclosure, and together with illustrations thereof, serve to interpret principles of the present disclosure.

FIG. 1 is a schematic diagram of a structure of a single-layer vibrating diaphragm according to an embodiment of the present disclosure;

FIG. 2 is a schematic diagram of a structure of a vibrating diaphragm having a double-layer structure according to an embodiment of the present disclosure; and

FIGS. 3-4 are schematic diagrams of structures of a vibrating diaphragm having a three-layer structure according to embodiments of the preset disclosure.

Notes to reference signs:

11: modified thermoplastic polyester elastomer layer; 12: damping adhesive layer; 13: plastic base layer.

### DETAILED DESCRIPTION

Various exemplary embodiments of the present disclosure will be described in detail with reference to the drawings. It should be noted that, unless otherwise specifically indicated, relative arrangements of the components and steps, numerical expressions and values illustrated in the embodiments do not limit the scope of the present disclosure.

The following descriptions of at least one exemplary embodiment only serve for illustrative purposes, and shall not impose any limitation upon the present disclosure and application or use thereof.

Technologies, methods and equipment known to those skilled in the relevant field may not be discussed in detail, but should be deemed as part of the Description under appropriate conditions.

Any specific value in all the embodiments to be shown and discussed herein should be interpreted as merely an example rather than a limitation. Thus other examples of exemplary embodiments may have different values.

It should be noted that similar labels and letters indicate similar items in the following drawings, and thus a certain item, once defined in one figure, needn't be further discussed in subsequent figures.

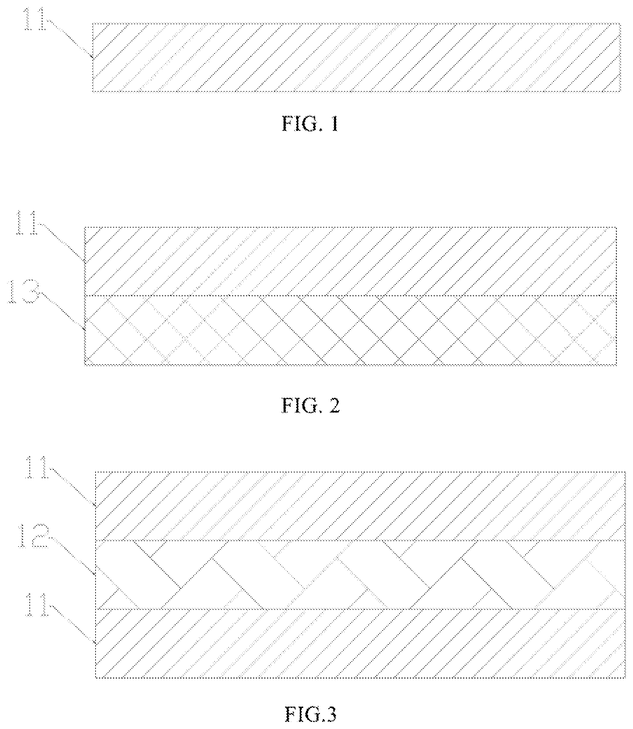

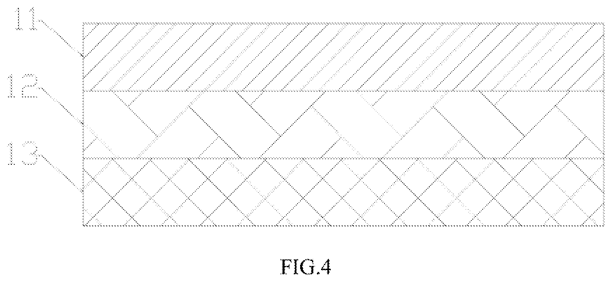

FIG. 1 is a schematic diagram of a structure of a single-layer vibrating diaphragm according to an embodiment of the present disclosure, FIG. 2 is a schematic diagram of a structure of a vibrating diaphragm having a double-layer structure according to an embodiment of the present disclosure, and FIGS. 3-4 are schematic diagrams of structures of a vibrating diaphragm having a three-layer structure according to embodiments of the preset disclosure.

As shown in FIG. 1, a vibrating diaphragm for a sound generating device is provided. The vibrating diaphragm includes at least one modified thermoplastic polyester elastomer layer 11, wherein a modifier is at least one of a temperature-resistant resin, an inorganic filler and an anti-aging agent, and the modifier is added to a thermoplastic polyester elastomer material. The modifier can improve the temperature resistance of the thermoplastic polyester elastomer material. The temperature resistance refers to a property of high temperature resistance, i.e., a property of maintaining structural strength at a set temperature, e.g., above 220° C.

In embodiments of the present disclosure, when preparing a diaphragm layer, a modifier is added to a thermoplastic polyester elastomer material (TPEE) and is sufficiently mixed therewith to achieve the aim of improving the temperature resistance of a moulded vibrating diaphragm. A temperature-resistant resin and an inorganic filler can be combined with the thermoplastic polyester elastomer material so as to increase a melting temperature of the modified thermoplastic polyester elastomer layer 11 to improve the temperature resistance of the material. Besides, an anti-aging agent can delay an aging speed of the thermoplastic polyester elastomer material, thereby improving the temperature resistance of the material.

The present disclosure further provides a method for preparing a vibrating diaphragm, the method including:

S1. a thermoplastic polyester elastomer material and a modifier are provided, wherein the modifier is at least one of a temperature-resistant resin, an inorganic filler and an anti-aging agent. The temperature-resistant resin, the inorganic filler and the anti-aging agent may adopt, but are not limited to, materials disclosed in embodiments of the present disclosure;

S2. the modifier is added to the thermoplastic polyester elastomer material, and the modifier and the thermoplastic polyester elastomer material are mixed uniformly; and

S3. the modifier and the thermoplastic polyester elastomer material mixed are moulded to form a vibrating diaphragm.

The method has characteristics of simple process, good moulding quality and fast speed.

In one example, S2 includes:

the thermoplastic polyester elastomer material and the modifier are added to a twin-screw extruder, and the thermoplastic polyester elastomer material and the modifier are melt-mixed to form a uniform melt.

In the method, the thermoplastic polyester elastomer material and the modifier are processed once by the twin-screw extruder to form a melt. The method has a fast processing speed.

Preferably, prior to melt-mixing, the method further includes the step that the thermoplastic polyester elastomer material and the modifier are dried. By drying, moisture in the thermoplastic polyester elastomer material and the modifier can be removed effectively to avoid the moisture adversely affecting the surface of the vibrating diaphragm during the moulding process.

In another example, S2 includes:

first, the thermoplastic polyester elastomer material and the modifier are mixed and the thermoplastic polyester elastomer material and the modifier are prepared into a masterbatch: and

then the masterbatch and the thermoplastic polyester elastomer material are added to a single-screw extruder and the masterbatch and the thermoplastic polyester elastomer material are melt-mixed to form a uniform melt.

In this method, first, the thermoplastic polyester elastomer material and the modifier are mixed and (hereafter prepared into a masterbatch. For example, a twin-screw extruder is used for preparing the masterbatch, and the twin-screw extruder can produce a masterbatch of a high concentration. Then, a single-screw extruder is used to further process the thermoplastic polyester elastomer material and the masterbatch to prepare a vibrating diaphragm. Compared with the twin-screw extruder, the single-screw extruder has a simpler structure and a lower cost.

The method reduces the equipment cost of a manufacturer for preparing the vibrating diaphragm. The process of preparing the masterbatch and the process of melt-mixing to prepare the vibrating diaphragm may be performed by two manufacturers respectively, and the manufacturer for preparing the vibrating diaphragm only needs to directly purchase the masterbatch and use a single-screw extruder to further process the masterbatch and the thermoplastic polyester elastomer material without replacement of a twin-screw extruder having a more complicated structure and a higher cost.

Similarly, before melt-mixing, the method further includes the step that the thermoplastic polyester elastomer material and the modifier are dried. By drying, moisture in the thermoplastic polyester elastomer material and the modifier can be removed effectively to avoid the moisture adversely affecting tic surface of the vibrating diaphragm during the moulding process.

With the two methods, a diaphragm layer with a uniform thickness and stable quality may be formed.

Optionally, in S3, the melt is formed into a diaphragm layer by tape casting.

Those skilled in the art can set the kinds, amounts and the like of the thermoplastic polyester elastomer material and the modifier according to actual needs.

In one example, the temperature-resistant resin refers to a resin unlikely to melt at a set temperature. For example, the melting temperature of the temperature-resistant resin is higher than 240° C., and a melting index thereof is 1-20 g/10 min. Optionally, the temperature-resistant resin is at least one of poly(ethyleneglycol o-phthalate) (PET), polyethylene naphthalate (PEN) and poly 1,4-cyclohexylene dimethylene terephthalate (PCT). The temperature-resistant resin and the thermoplastic polyester elastomer material have high bonding strength, which may significantly increase the melting temperature of the material.

Those skilled in the art can select the kinds, proportions and the like of the temperature-resistant resin according to actual needs.

The inorganic filler has a relatively high melting point. Optionally, the inorganic filler is at least one of talc, calcium carbonate, glass fiber, carbon fiber, glass beads, and mica. The inorganic fillers are added to the thermoplastic polyester elastomer material in the form of powder. These inorganic fillers have good bonding strength with the thermoplastic polyester elastomer material, which may significantly increase the melting temperature of the material.

Those skilled in the art can select the kinds, proportions and the like of the inorganic filler according to actual needs.

The temperature-resistant resin and the inorganic filler have a predetermined bonding force with the thermoplastic polyester elastomer material. The stronger the bonding force is, the higher the melting temperature of the modified thermoplastic polyester elastomer material is and the higher the temperature-resistance of the material is.

In a preferred example, under the condition that the modifier includes at least one of a temperature-resistant resin and an inorganic filler, the modifier further includes a coupling agent for improving bonding strength between the thermoplastic polyester elastomer material and at least one of the temperature-resistant resin and the inorganic filler. The coupling agent enables physical coupling between the temperature-resistant resin and/or the inorganic filler and the thermoplastic elastomer, thereby improving a bonding force.

In this example, the coupling agent can significantly improve the bonding force between the thermoplastic polyester elastomer and the temperature-resistant resin and/or the inorganic filler, e.g., van der Waals force and hydrogen bonds. The higher the bonding force is, the higher the melting temperature of the material is. Addition of the coupling agent can significantly improve the melting temperature of the material.

Optionally, the coupling agent is selected from at least one of a silane coupling agent, an epoxy polymer coupling agent, and a titanate coupling agent. The above coupling agents have good compatibility and a high bonding force with the temperature-resistant resin and the inorganic filler.

Those skilled in the art may select the kinds, proportions and the like of the coupling agent according to actual needs.

An anti-aging agent can resist aging under thermal conditions and oxidation aging. Adding an anti-aging agent to the thermoplastic polyester elastomer material can delay the aging speed of the material, thereby improving the temperature resistance of the material. Those skilled in the art can select a common anti-aging agent in the art.

Optionally, the anti-aging agent is an antioxidant. For example, the antioxidant is at least one of an antioxidant 1010 and an antioxidant 168. The above antioxidants can slow down the speed of aging under thermal conditions and oxidation aging of the material, and improve the temperature-resistance of the material.

The higher the content of the modifier is, the better the temperature-resistance of the diaphragm layer is, but the structural strength of the diaphragm layer will become worse.

Preferably, the amount of the modifier added occupies less than or equal to 40% of the total mass of the modified thermoplastic polyester elastomer material.

Those skilled in the art can set the structure of the vibrating diaphragm according to actual needs.

In one example, as shown in FIG. 1, the vibrating diaphragm is of a single-layer diaphragm structure. The diaphragm layer is made of the modified thermoplastic polyester elastomer layer 11. The vibrating diaphragm has a simple structure, high strength and good temperature resistance.

In one example, as shown in FIG. 3, the vibrating diaphragm is of a composite structure. Under the condition that the vibrating diaphragm includes two modified thermoplastic polyester elastomer layers 11, the vibrating diaphragm further includes a damping adhesive layer 12 positioned between the two modified thermoplastic polyester elastomer layers 11. In this example, since the damping adhesive layer 12 is sticky and can form an adhesive force with other diaphragm layers, the modified thermoplastic elastomer layers can be directly bonded to the damping adhesive layer 12 during manufacturing.

The vibrating diaphragm has characteristics of good temperature resistance and a good damping effect and is easy to process.

In one example, as shown in FIG. 2, the vibrating diaphragm is of a composite structure. Under the condition that the vibrating diaphragm includes one modified thermoplastic polyester elastomer layer 11, the vibrating diaphragm further includes a plastic base layer 13 bonded to the modified thermoplastic polyester elastomer layer 11. In this example, the modified thermoplastic polyester elastomer layer 11 and the plastic base layer 13 may be hot pressed together with a hot press bonding method.

The vibrating diaphragm has characteristics of good temperature resistance and high structural strength.

In one example, as shown in FIG. 4, the vibrating diaphragm is of a composite structure. Under the condition that the vibrating diaphragm includes one modified thermoplastic polyester elastomer layer 11, the vibrating diaphragm further includes the plastic base layer 13 and the damping adhesive layer 12 positioned between the modified thermoplastic polyester elastomer layer 11 and the plastic base layer 13.

In this example, the modified thermoplastic polyester elastomer layer 11 and the plastic base layer 13 may be directly adhered to an upper side and a lower side of the damping adhesive layer 12, respectively. The preparation of the vibrating diaphragm is very simple.

The vibrating diaphragm has characteristics of good temperature resistance, a good damping effect and high structural strength.

Preferably, in the above example, the plastic base layer 13 is made of at least one of polyetheretherketone (PEEK), polyarylate (PAR), polyetherimide (PEI), polyimide (PI), polyphenylene sulfide (PPS), polyethylene naphthalate (PEN), polyethylene terephthalate (PET), and polybutylene terephthalate (PBT). The above materials have characteristics of low processing difficulty, a good moulding effect and high structural strength.

Those skilled in the art may select the kinds, proportions and the like of the plastic base layer 13 according to actual needs.

In other examples, in order to improve the comprehensive performance of the vibrating diaphragm, additives such as plasticizers, compatibilizers, heat stabilizers, light stabilizers, lubricants and flame retardants may be further added during melt-mixing. Those skilled in the art may select common additives in the art and their amounts according to actual needs.

Of course, the number of the layers of the vibrating diaphragm is not limited herein. The vibrating diaphragm may also include four diaphragm layers, five diaphragm layers, etc., as long as it includes at least one modified thermoplastic elastomer layer.

According to another embodiment of the present disclosure, a sound generating device is provided, which includes the vibrating diaphragm for a sound generating device provided by the present disclosure.

In one example, a sound generating device includes a vibrating system and a magnetic circuit system. The vibrating system includes a vibrating diaphragm and a sound coil connected to the vibrating diaphragm. Optionally, the vibrating diaphragm is a flat vibrating diaphragm or a folded-ring vibrating diaphragm. The folded-ring vibrating diaphragm includes a central portion, a folded-ring portion disposed surrounding the central portion, and an edge portion disposed surrounding the folded-ring portion. The sound coil is adhered to the central portion. The magnetic circuit system is used to form a magnetic field. The free end of the sound coil is positioned in the magnetic field. The operating principles of the magnetic circuit system and the vibrating system are common knowledge in the art and will not be described in detail herein.

The sound generating device has characteristics of a wide operating temperature range, a good sound generating effect and good durability.

Although some particular embodiments of the present disclosure are described in detail by means of examples, those skilled in the art should understand that the above examples serve only for illustrative purposes rather than limit the scope of the present disclosure. Those skilled in the an should understand that variations may be made to the above embodiments, without departing from the spirit and scope of the present disclosure, and the scope of the present disclosure shall be limited by the attached claims.

1. A vibrating diaphragm for a sound generating device, comprising:
at least one modified thermoplastic polyester elastomer layer, comprising a modifier selected from the group consisting of a temperature-resistant resin, an inorganic filler and an anti-aging agent, and
wherein the modifier is added an additive to a thermoplastic polyester elastomer material.

2. Vibrating diaphragm for a sound generating device according to claim 1, wherein the temperature-resistant resin is selected from the group consisting of at least one of poly(ethyleneglycol o-phthalate), polyethylene naphthalate and poly 1,4-cyclohexylene dimethylene terephthalate.

3. The vibrating diaphragm for a sound generating device according to claim 1, wherein the inorganic filler is selected from the group consisting of talc, calcium carbonate, glass fiber, carbon fiber, glass beads, and mica.

4. The vibrating diaphragm for a sound generating device according to claim 1, wherein under the condition that the modifier comprises at least one of a temperature-resistant resin and an inorganic filler, the modifier further comprises a coupling agent for improving bonding strength between the thermoplastic polyester elastomer material and at least one of the temperature-resistant resin and the inorganic filler.

5. The vibrating diaphragm for a sound generating device according to claim 4, wherein the coupling agent is selected from the group consisting of at least one of a silane coupling agent, an epoxy polymer coupling agent and a titanate coupling agent.

6. The vibrating diaphragm for a sound generating device according to claim 1, wherein an amount of the modifier added occupies less than or equal to 40% of a total mass of the modified thermoplastic polyester elastomer material.

7. The vibrating diaphragm for a sound generating device according to claim 1, wherein under the condition that the vibrating diaphragm comprises two modified thermoplastic polyester elastomer layers, the vibrating diaphragm further comprises a damping adhesive layer positioned between the two modified thermoplastic polyester elastomer layers.

8. The vibrating diaphragm for a sound generating device according to claim 1, wherein under the condition that the vibrating diaphragm comprises one modified thermoplastic polyester elastomer layer, the vibrating diaphragm further comprises a plastic base layer bonded to the modified thermoplastic polyester elastomer layer.

9. The vibrating diaphragm for a sound generating device according to claim 1, wherein under the condition that the vibrating diaphragm comprises one modified thermoplastic polyester elastomer layer, the vibrating diaphragm further comprises a plastic base layer and a damping adhesive layer positioned between the modified thermoplastic polyester elastomer layer and the plastic base layer.

10. A method for preparing a vibrating diaphragm, comprising: providing a thermoplastic polyester elastomer material and a modifier, wherein the modifier is selected from the group consisting of a temperature-resistant resin, an inorganic filler and an anti-aging agent;
adding the modifier to the thermoplastic polyester elastomer material and mixing uniformly the modifier and the thermoplastic polyester elastomer material; and
molding the modifier and the thermoplastic polyester elastomer material mixed to form a vibrating diaphragm.

11. The method for preparing a vibrating diaphragm according to claim 10, wherein the adding the modifier to the thermoplastic polyester elastomer material and mixing uniformly the modifier and the thermoplastic polyester elastomer material comprises:
adding the thermoplastic polyester elastomer material and the modifier to a twin-screw extruder, and melt-mixing the thermoplastic polyester elastomer material and the modifier to form a uniform melt; or
mixing the thermoplastic polyester elastomer material and the modifier and preparing the thermoplastic polyester elastomer material and the modifier into a masterbatch, and
adding the masterbatch and the thermoplastic polyester elastomer material to a single-screw extruder, and melt-mixing the masterbatch and the thermoplastic polyester elastomer material to form a uniform melt.

12. A sound generating device, comprising the vibrating diaphragm for a sound generating device according to claim 1.
